(19) United States
(12) Patent Application Publication
(10) Pub. No.: US 2013/0249918 A1
(43) Pub. Date: Sep. 26, 2013

(54) METHOD OF FORMING DRAWING PATTERN, METHOD OF GENERATING DRAWING DATA, AND DRAWING DATA GENERATING DEVICE

(71) Applicant: KABUSHIKI KAISHA TOSHIBA, Tokyo (JP)

(72) Inventors: Yoko TAKEKAWA, Tokyo (JP); Shigeki Nojima, Kanagawa (JP); Satoshi Tanaka, Kanagawa (JP); Masato Saito, Tokyo (JP)

(73) Assignee: KABUSHIKI KAISHA TOSHIBA, Tokyo (JP)

(21) Appl. No.: 13/826,233

(22) Filed: Mar. 14, 2013

(30) Foreign Application Priority Data
Mar. 23, 2012 (JP) 2012-068096

(51) Int. Cl. G06T 11/20

(52) U.S. Cl. CPC G06T 11/203
USPC 345/441

(57) ABSTRACT

According to a method of forming a drawing pattern of an embodiment, by setting the positions of drawing shots for a drawing pattern, drawing data is generated based on pattern data. A plurality of types of drawing data are generated based on one type of pattern data by setting the positions of the drawing shots to positions different for each piece of the drawing data when the drawing data is generated. In addition, multiple exposures are performed for the substrate by using the plurality of types of the drawing data when the drawing pattern is formed on the substrate.

### CROSS-REFERENCE TO RELATED APPLICATIONS

This application is based upon and claims the benefit of priority from Japanese Patent Application No. 2012-068096, filed on Mar. 23, 2012; the entire contents of which are incorporated herein by reference.

### FIELD

Embodiments relates generally to a method of forming a drawing pattern, a method of generating drawing data, and a drawing data generating device.

### BACKGROUND

As pattern data used in a lithography process performed when a semiconductor device is manufactured, there are mask data of a photomask, mask data of an imprint mask (template), data of a pattern drawn on a substrate such as a wafer using electron beams, and the like.

The pattern data is data of a pattern drawn on a photomask, a template, a wafer, or the like, and the pattern data of each drawing shot is generated by dividing the whole pattern data for each drawing shot. Thus, by drawing a pattern that corresponds to the pattern data on the substrate for each drawing shot, an on-substrate pattern is formed.

In such an on-substrate pattern, there are joints between each drawing shots, and, in a case where the on-substrate pattern is formed, a variation in the size of the pattern may easily occur due to the joints of the drawing shots. Accordingly, it is desired that an on-substrate pattern having a desired size is formed.

### BRIEF DESCRIPTION OF THE DRAWINGS

FIG. 1 is a diagram that illustrates the concept of a drawing pattern generating process according to an embodiment;

FIG. 2 is a block diagram that illustrates the configuration of a drawing data generating device according to an embodiment;

FIG. 3 is a flowchart that illustrates the processing sequence of the process of a method of forming a drawing pattern;

FIG. 4 is a flowchart that illustrates the processing sequence of a drawing data generating process;

FIG. 5 is diagram that illustrates an example of a multiple exposure setting area;

FIG. 6 is a diagram that illustrates set positions of drawing shots;

FIG. 7 is a diagram that illustrates a line end setting process using the addition of offsets;

FIG. 8 is a diagram that illustrates a line end setting process using the addition of protruded patterns;

FIG. 9 is a diagram that illustrates a line end setting process using the expansion and contraction of line ends;

FIG. 10 is a diagram that illustrates a line end setting process using the addition of dummy patterns;

FIG. 11 is a diagram that illustrates a process of setting a plurality of separation positions for pattern data;

FIG. 12 is a diagram that illustrates drawing data generated based on pattern data;

FIG. 13 is a diagram that illustrates the shape of a drawing pattern formed on a substrate by using a plurality of types of drawing data;

FIG. 14 is a diagram that illustrates a process of setting separation positions for each one pattern; and

FIG. 15 is a diagram that illustrates the hardware configuration of a drawing data generating device.

### DETAILED DESCRIPTION

According to an embodiment, a method of forming a drawing pattern is provided. In the method of forming a drawing pattern, drawing data is generated based on pattern data by setting the positions of drawing shots for the pattern data of a drawing pattern to be drawn on a substrate. Then, by drawing a drawing pattern corresponding to the drawing data on the substrate, the drawing pattern is formed on the substrate. When the drawing data is to be generated, by setting the position of a drawing shot to a position that differs for each drawing data, a plurality of types of drawing data are generated based on one type of pattern data. In addition, when the drawing pattern is formed, a multiple exposure is performed for the substrate by using the plurality of types of drawing data.

Hereinafter, a method of forming a drawing pattern, a method of generating drawing data, and a drawing data generating device according to embodiments will be described in detail with reference to the attached drawings. However, the present invention is not limited to the embodiments.

### Embodiments

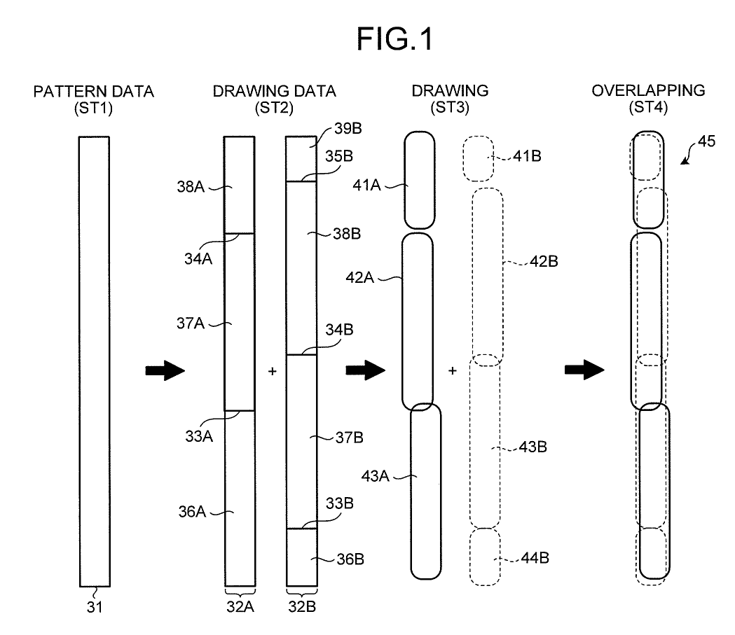

FIG. 1 is a diagram that illustrates the concept of a drawing pattern generating process according to an embodiment. Pattern data 31 of an on-substrate pattern to be formed (drawn) on a substrate (a photomask, a template, a wafer, or the like) is generated in Step ST1. Thereafter, by setting predetermined separation positions in the pattern data 31, the pattern data 31 is divided into areas for each drawing shot. In this embodiment, by dividing the pattern data 31 at various separation positions, a plurality of types of drawing data (graphic data such as VSB data) 32A and 32B of which the division positions are shifted are generated in Step ST2. Each generated drawing data is pattern data acquired by dividing the pattern data 31 according to drawing shots. When a drawing pattern that corresponds to the pattern data 31 is formed on the substrate, a drawing pattern is formed on the substrate for each drawing shot. Here, a case will be described in which two types of drawing data are generated by using two types of separation methods.

For example, by dividing the pattern data 31 into data of three areas using two separation positions 33A and 34A, which is a first separation method, first drawing data 32A is generated. From this, the first drawing data 32A is configured by drawing pattern areas 36A, 37A, and 38A.

Similarly, by dividing the pattern data 31 into data of four areas using three separation positions 33B, 34B, and 35B, which is a second separation method, second drawing data 32B is generated. From this, the second drawing data 32B is configured by drawing pattern areas 36B, 37B, 38B, and 39B.

In other words, by dividing the pattern data 31 into three drawing shots, the first drawing data 32A in which the drawing pattern areas 36A to 38A are set is generated. Similarly, by dividing the pattern data 31 into four drawing shots, the second drawing data 32B in which the drawing pattern areas 36B to 39B are set is generated.

In this case, the separation positions 33A and 34A of the first drawing data 32A and the separation positions 33B, 34B, and 35B of the second drawing data 32B are set to different separation positions. In other words, any one of the drawing pattern areas 36A to 38A is set to an area that is different from the drawing pattern areas 36B and 39B. In this way, by setting the positions of the drawing shots to positions different for each drawing data, a plurality of types of drawing data are generated based on one type of the pattern data 31 in Step ST3.

Thereafter, a drawing pattern is formed on the substrate for each drawing shot. More specifically, by drawing (for example, EB drawing) drawing patterns corresponding to the drawing data, the drawing patterns are formed on the substrate.

For example, a drawing pattern is formed on a substrate by using the first drawing data 32A, and thereafter, a drawing pattern is formed on the substrate by using the second drawing data 32B. Thereafter, a multiple exposure is performed for the substrate by using the first drawing data 32A and the second drawing data 32B. In other words, after a first drawing pattern is drawn using the first drawing data 32A, a second drawing pattern is drawn using the second drawing data 32B on the first drawing pattern.

For example, a drawing pattern 41A corresponding to the drawing pattern area 38A is formed, and, thereafter, a drawing pattern 42A corresponding to the drawing pattern area 37A is formed. In addition, a drawing pattern 43A corresponding to the drawing pattern area 36A is formed. Thereafter, a drawing pattern 41B corresponding to the drawing pattern area 39B is formed, and, thereafter, a drawing pattern 42B corresponding to the drawing pattern area 38B is formed. Furthermore, a drawing pattern 43B corresponding to the drawing pattern area 37B is formed, and, thereafter, a drawing pattern 44B corresponding to the drawing pattern area 36B is formed in Step ST3. In this way, an on-substrate pattern 45 acquired by overlapping the first drawing pattern and the second drawing pattern is formed on the substrate in Step ST4.

In a case where the separation positions of the first drawing data and the second drawing data overlap each other, the separation positions of the first drawing pattern and the second drawing pattern formed on the substrate overlap each other as well. When the separation positions of the drawing patterns overlap each other, a size variation in the pattern size becomes obvious near the separation position (shot joining portion), whereby a discrepancy in the size may easily occur. Particularly, in an imprint such as nano-imprint lithography (NIL), a template having a same-size mask is used, and accordingly, a size variation in the pattern size is remarkable.

In this embodiment, a plurality of types of drawing data are generated by shifting separation positions (division positions) of the drawing patterns, and multiple drawing is performed, whereby a size discrepancy (a variation caused by the connection of shots) in the pattern size near the separation position can be decreased.

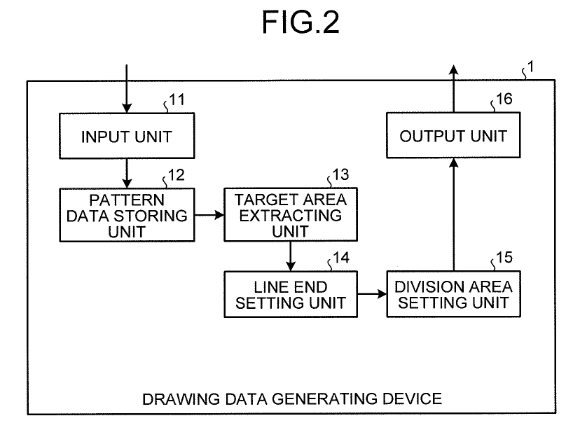

FIG. 2 is a block diagram that illustrates the configuration of a drawing data generating device according to an embodiment. The drawing data generating device 1 is a computer that generates a plurality of types of drawing data based on pattern data of a pattern to be formed on a substrate or the like. The drawing data generating device 1 according to this embodiment generates a plurality of types of drawing data based on one pattern data by shifting the separation positions of the drawing pattern to various positions. In other words, the drawing data generating device 1 generates a plurality of types of drawing data by shifting the positions of drawing shots set for pattern data within the pattern data.

In description presented below, a case will be described in which the drawing data generating device 1 generates a plurality of types of drawing data based on pattern data of a template pattern. Accordingly, the drawing data generated by the drawing data generating device 1 is data of a pattern drawn in a template (original form).

The drawing data generating device 1 includes an input unit 11, a pattern data storing unit 12, a target area extracting unit 13, a line end setting unit 14, a division area setting unit (drawing shot setting unit) 15, and an output unit 16. The input unit 11 receives pattern data transmitted from an external device (a pattern data generating device generating the pattern data or the like) as an input and transmits the pattern data to the pattern data storing unit 12. The pattern data storing unit 12 is a memory storing pattern data or the like.

The target area extracting unit 13 extracts an area (a multiple exposure setting area for which multiple exposure is performed) in which a plurality of types of drawing data are generated from the pattern data (a pattern data area 100 to be described later) stored inside the pattern data storing unit 12. The target area extracting unit 13 extracts an area (an area in which a fine pattern is arranged) in which drawing accuracy is required from the pattern data as a multiple exposure setting area. The target area extracting unit 13 transmits the extracted multiple exposure setting area to the line end setting unit 14.

The line end setting unit 14 sets line ends (pattern ends) in each pattern within the multiple exposure setting area. The line end is a reference position for setting a separation position in the pattern data. When the separation positions are set, the multiple exposure setting area is separated such that the line ends coincide with the shot separation of drawing shots.

The line end setting unit 14 according to this embodiment groups the inside of the multiple exposure setting area for each pattern group. The line end setting unit 14, for example, groups patterns inside the multiple exposure setting area into a plurality of sets such that patterns, which are adjacent to each other, having the same pattern pitch are grouped into the same set. The line end setting unit 14 extracts one pattern from each pattern group that has been grouped and sets N types (here, N is a natural number of two or more) of line ends for each extracted pattern. The line end setting unit 14 transmits information relating to the multiple exposure setting area and the set positions of line ends to the division area setting unit 15.

The division area setting unit 15 divides each pattern group formed within the multiple exposure setting area into drawing shots based on the positions of the line ends set by the line end setting unit 14. More specifically, after the separation positions are set such that the line ends coincide with the shot separation of the drawing shots, the division area setting unit 15 sets other separation positions such that drawing shots are adjacently arranged. From this, separation positions are set for each pattern data of each pattern group. In other words, each pattern group is divided into a plurality of drawing shots by the shot separation of a plurality of drawing shots. As a result, drawing shots are set in each pattern formed inside the multiple exposure setting area.

In this way, the division area setting unit 15 generates drawing data by dividing the multiple exposure setting area into a plurality of drawing shots (drawing pattern areas). The division area setting unit 15 according to this embodiment sets separation positions for each set line end. From this, the division area setting unit 15 generates N types of drawing data for each pattern group. The division area setting unit 15 transmits the generated N types of drawing data to the output unit 16. The output unit 16 outputs the drawing data to an external device (a drawing device or the like).

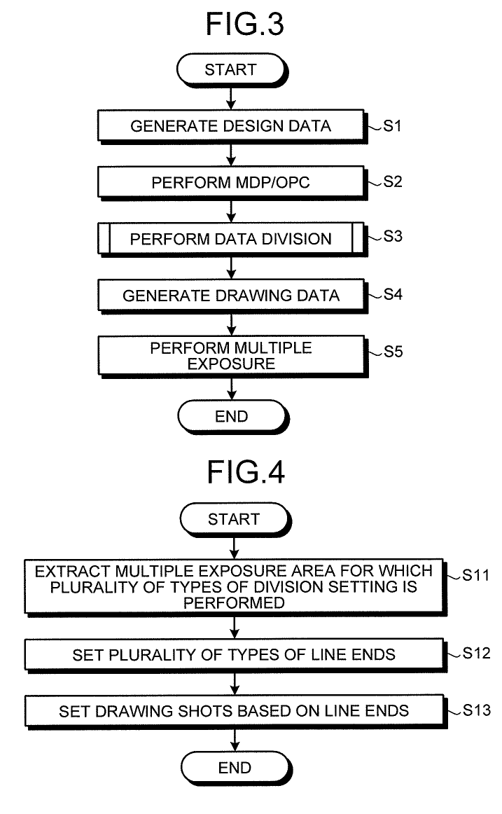

FIG. 3 is a flowchart that illustrates the processing sequence of a drawing pattern forming process. Design data (layout pattern data) of a pattern to be formed on a substrate such as a template is generated in Step S1. In addition, by performing mask data preparation (MDP) or optical proximity correction (OPC) for the design data, pattern data 31 is generated in Step S2.

Thereafter, the drawing data generating device 1 divides the pattern data 31 at predetermined separation positions, thereby dividing the pattern data 31 into areas for each drawing shot in Step S3. The drawing data generating device 1 performs various data divisions, thereby generating a plurality of types of drawing data in Step S4.

A drawing device performing electron beam (EB) drawing for a substrate performs a multiple exposure for the substrate by using a plurality of types of drawing data that has been generated in Step S5. For example, in a case where N types of drawing data are generated, the drawing device performs N times of multiple exposures by sequentially using the N types of drawing data. From this, a drawing pattern is formed on the substrate.

FIG. 4 is a flowchart that illustrates the processing sequence of a drawing data generating process. The input unit 11 of the drawing data generating device 1 receives pattern data transmitted from an external device as an input and transmits the pattern data to the pattern data storing unit 12. The pattern data storing unit 12 stores the pattern data.

The target area extracting unit 13 extracts a multiple exposure setting area, which is an area for which a plurality of types of division setting is performed, from the pattern data area 100 arranged inside the pattern data storing unit 12 based on a predetermined extraction condition and transmits the multiple exposure setting area to the line end setting unit 14 in Step S11.

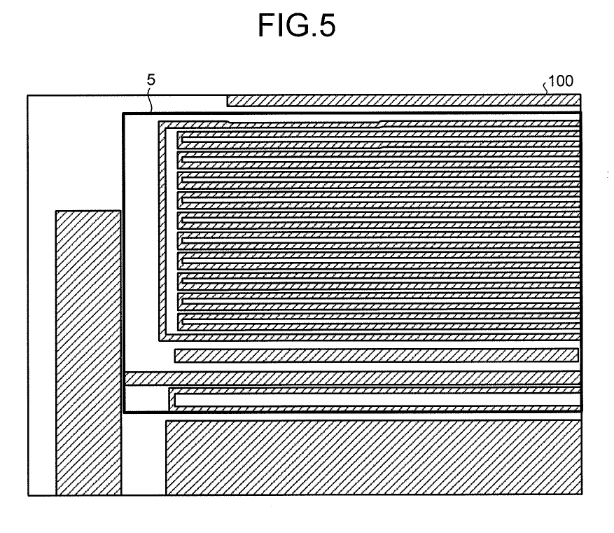

FIG. 5 is diagram that illustrates an example of the multiple exposure setting area. The target area extracting unit 13 extracts an area (for example, an area in which a pattern is formed at a minimum pitch) in which a fine pattern of a size smaller than a predetermined size is arranged from the pattern data area 100 as the multiple exposure setting area 5.

The line end setting unit 14 groups the inside of the multiple exposure setting area 5 into pattern groups and extracts one arbitrary pattern from each pattern group and sets a plurality of types (N types) of line ends for the extracted one pattern in Step S12. The line end setting unit 14 transmits information relating to the multiple exposure setting area 5 and the set positions of line ends to the division area setting unit 15.

The division area setting unit 15 sets drawing shots in the multiple exposure setting area 5 based on the positions of the line ends that are set by the line end setting unit 14 in Step S13, thereby generating drawing data. The division area setting unit 15 according to this embodiment sets drawing shots for each line end, thereby generating drawing data corresponding to the same number (N) as the number of set line ends.

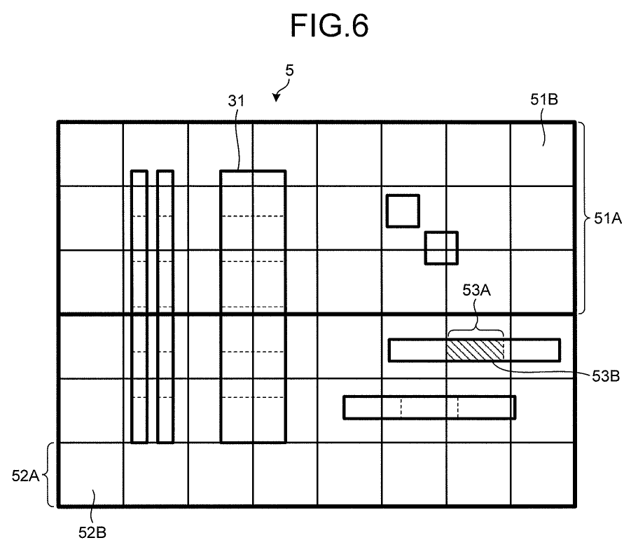

Here, the set positions of the drawing shots will be described. FIG. 6 is a diagram illustrating set positions of drawing shots. FIG. 6 illustrates an example of the pattern data 31 arranged inside the multiple exposure setting area 5. A pattern data area other than the multiple exposure setting area 5 also has a configuration that is the same as that of the multiple exposure setting area 5 illustrated in FIG. 5.

The multiple exposure setting area 5 is configured by one or a plurality of frames 51B having a predetermined frame width 51A. The frame 51B is a drawing area for which drawing can be performed in accordance with the movement of a main inclination area according to the movement of a stage. In addition, in each frame 51B, a plurality of subfields 52B having a predetermined subfield width 52A is set. In other words, the multiple exposure setting area 5 is divided into a plurality of frames 51B, and each frame 51B is divided into a plurality of subfields 52B. From this, each pattern data 31 is divided into a plurality of frames 51B and is divided into a plurality of subfields 52B.

In addition, each pattern data 31 is separated into a plurality of drawing shots 53B having a predetermined shot width 53A. In this way, the pattern data 31 is separated into frames 51B, subfields 52B, and drawing shots 53B. In other words, the pattern data 31 is divided at frame boundaries that are boundaries between frames 51B, subfield boundaries that are boundaries between subfields 52B, and shot boundaries that are boundaries of drawing shots 53B. A large pattern having a pattern pitch larger than a predetermined value in the multiple exposure setting area 5 may be divided into drawing shots larger than the drawing shot 53B.

Next, an example of a line end setting process will be described. The line end setting unit 14, for example, sets line ends for the pattern data 31 (line end setting pattern) arranged inside the multiple exposure setting area 5 using a method of (1) adding offsets to the line ends, (2) adding protruded patterns, (3) expanding or contracting the line ends, (4) adding dummy patterns, or the like.

### (1) Adding Offset to Line End

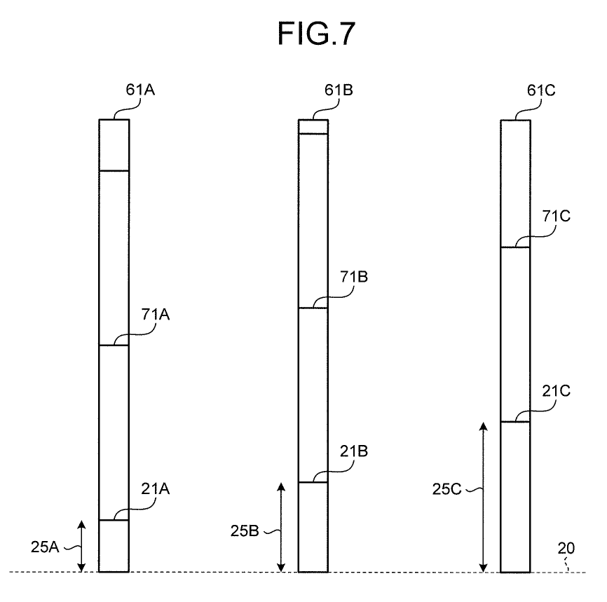

FIG. 7 is a diagram that illustrates the line end setting process using the addition of offsets. FIG. 7 illustrates the line end setting process in a case where the line ends are set by adding offsets to the line ends. In a case where offsets are added to line end setting patterns arranged inside the multiple exposure setting area 5, the line end setting unit 14 sets a plurality of types of offset sizes (offset sizes that are mutually different) for the line end setting patterns. FIG. 7 illustrates a case in which a first offset size 25A, a second offset size 25B, and a third offset size 25C having mutually different sizes are set for the line end setting patterns.

When the first offset size 25A is set for the line end setting pattern, the line end of the line end setting pattern becomes a line end 21A by moving from the original line end 20 by the first offset size 25A. When drawing shots are set by using the line end 21A as the reference, drawing data 61A having a separation position 71A is formed.

Similarly, when the second offset size 25B is set for the line end setting pattern, the line end of the line end setting pattern becomes a line end 21B by moving from the original line end 20 by the second offset size 25B. When drawing shots are set by using the line end 21B as the reference, drawing data 61B having a separation position 71B is formed.

Similarly, when the third offset size 25C is set for the line end setting pattern, the line end of the line end setting pattern becomes a line end 21C by moving from the original line end 20 by the third offset size 25C. When drawing shots are set by using the line end 21C as the reference, drawing data 61C having a separation position 71C is formed.

### (2) Adding Protruded Pattern

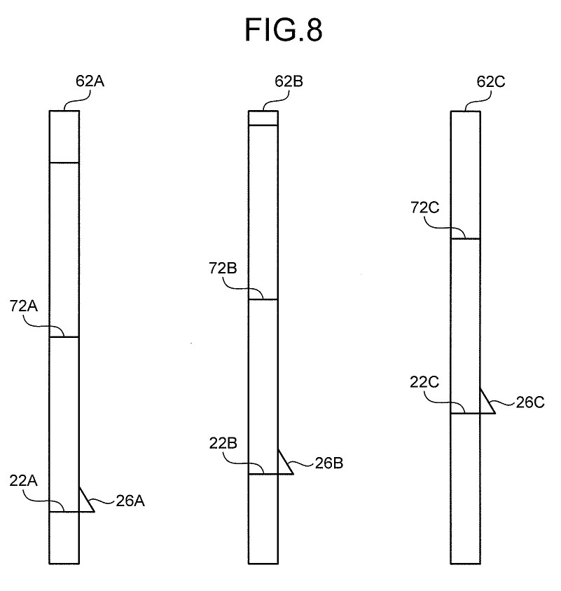

FIG. 8 is a diagram that illustrates the line end setting process using the addition of protruded patterns. FIG. 8 illustrates the line end setting process in a case where the line ends are set by adding protruded patterns to line end setting patterns. In a case where the protruded patterns are added to the line end setting pattern, the line end setting unit 14 adds the protruded patterns to various positions of the line end setting pattern. FIG. 8 illustrates a case in which the protruded patterns 26A, 26B, and 26C are set at a first position 22A, a second position 22B, and a third position 22C, which are mutually different positions, for the line end setting pattern.

The protruded patterns 26A, 26B, and 26C are fine patterns that do not influence the on-substrate pattern. In a case where the substrate is a photomask, the protruded patterns 26A, 26B, and 26C, for example, are fine patterns that are not resolved on the wafer. On the other hand, in a case where the substrate is a template, the protruded patterns 26A, 26B, and 26C, for example, are fine patterns in which a resist is not filled.

The line end setting unit 14 sets the position of the protruded patterns as line ends. From this, when the protruded pattern 26A is set for the line end setting pattern, the line end of the line end setting pattern becomes a line end 22A located at a position that is approximately the same as the position of the protruded pattern 26A. When drawing shots are set by using the line end 22A as the reference, drawing data 62A having a separation position 72A is formed.

Similarly, when the protruded pattern 26B is set for the line end setting pattern, the line end of the line end setting pattern becomes a line end 22B located at a position that is approximately the same as the position of the protruded pattern 26B. When drawing shots are set by using the line end 22B as the reference, drawing data 62B having a separation position 72B is formed.

Similarly, when the protruded pattern 26C is set for the line end setting pattern, the line end of the line end setting pattern becomes a line end 22C located at a position that is approximately the same as the position of the protruded pattern 26C. When drawing shots are set by using the line end 22C as the reference, drawing data 62C having a separation position 72C is formed.

### (3) Expanding or Contracting Line End

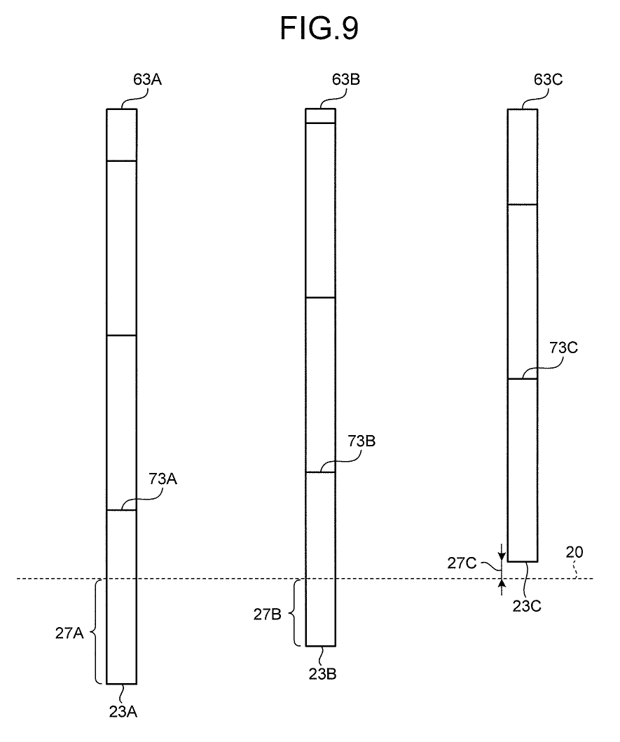

FIG. 9 is a diagram that illustrates a line end setting process using the expansion and contraction of line ends. FIG. 9 illustrates the line end setting process in a case where the line ends are set by expanding or contracting the line ends of the line end setting patterns in the longitudinal direction. In a case where the line end of the line end setting pattern is expanded or contracted, the line end setting unit 14 sets a plurality of types of expansion/contraction sizes as the line end setting patterns. FIG. 9 illustrates cases where a first expansion/contraction size 27A, a second expansion/contraction size 27B, and a third expansion/contraction size 27C are set for the line end setting pattern.

When the first expansion/contraction size 27A is set for the line end setting pattern, the line end of the line end setting pattern becomes a line end 23A by moving from the original line end 20 by the first expansion/contraction size 27A. When drawing shots are set by using the line end 23A as the reference, drawing data 63A having a separation position 73A is formed.

Similarly, when the second expansion/contraction size 27B is set for the line end setting pattern, the line end of the line end setting pattern becomes a line end 23B by moving from the original line end 20 by the second expansion/contraction size 27B. When drawing shots are set by using the line end 23B as the reference, drawing data 63B having a separation position 73B is formed.

Similarly, when the third expansion/contraction size 27C is set for the line end setting pattern, the line end of the line end setting pattern becomes a line end 23C by moving from the original line end 20 by the third expansion/contraction size 27C. When drawing shots are set by using the line end 23C as the reference, drawing data 63C having a separation position 73C is formed.

For example, since only one exposure is performed at the time of performing multiple exposures, a pattern (expanded portion) in which the first expansion/contraction size 27A is set out of the line end setting patterns has a little influence on the on-wafer pattern. In this way, even in a case where the line end setting pattern is set, after multiple exposures are performed, there is a little influence on the wafer image accompanied with the expansion or contraction of the line end.

### (4) Adding Dummy Pattern

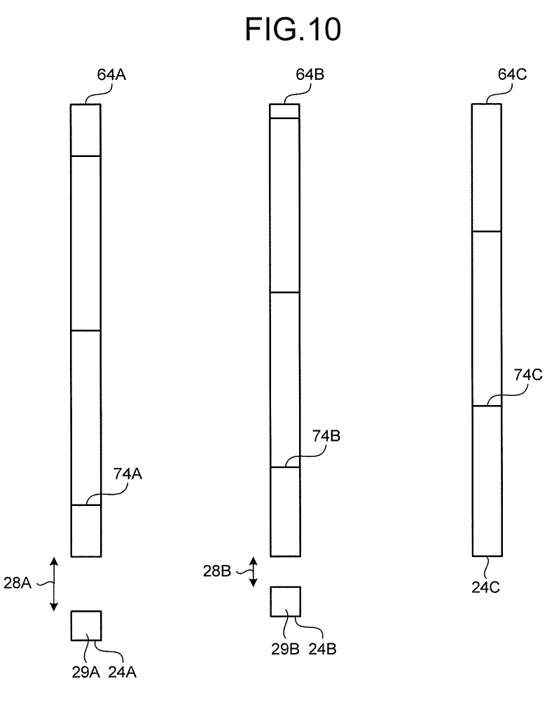

FIG. 10 is a diagram that illustrates a line end setting process using the addition of dummy patterns. FIG. 10 illustrates the line end setting process in a case where the line end is set by adding dummy patterns near the line end setting patterns. In a case where a dummy pattern is to be added near the line end setting pattern, the line end setting unit 14 adds a small dummy pattern (for example, sub-resolution assist features (SRAF)) that is not resolved on the wafer at a plurality of types of positions. The line end setting unit 14 adds dummy patterns at positions acquired by expanding the line end setting pattern in the longitudinal direction. FIG. 10 illustrates cases in which dummy patterns are set at positions separated by a first distance 28A and a second distance 28B, which are mutually difference distances.

A dummy pattern 29A is arranged at a position separated from the line end of line end setting pattern by the first distance 28A in the longitudinal direction of the line end setting pattern, and a dummy pattern 29B is arranged at a position separated from the line end of line end setting pattern by the second distance 28B in the longitudinal direction of the line end setting pattern.

When the dummy pattern 29A is added to the line end setting pattern at the position separated by the first distance 28A, the line end of the line end setting pattern becomes a line end 24A of the dummy pattern 29A. When drawing shots are set by using this line end 24A as the reference, drawing data 64A having a separation position 74A is formed.

Similarly, when the dummy pattern 29B is added to the line end setting pattern at the position separated by the second distance 28B, the line end of the line end setting pattern becomes a line end 24B of the dummy pattern 29B. When drawing shots are set by using this line end 24B as the reference, drawing data 64B having a separation position 74B is formed.

In addition, when a dummy pattern is not added to the line end setting pattern, the line end of the line end setting pattern is not moved and is the line end 24C that is the line end of the line end setting pattern. When drawing shots are set by using the line end 24C as the reference, drawing data 64C having a separation position 74C is formed.

Furthermore, the protruded patterns 26A to 26C may be removed after the generation of the drawing data 62A to 62C and may be left to remain when there is no influence thereof on the on-wafer pattern. In addition, in a case where the line end setting pattern is expanded or contracted, after the generation of the drawing data 63A to 63C, the expansion/contraction may be restored to the original state or may be remained to be expanded or contracted when there is no influence thereof on the on-wafer pattern. Furthermore, the dummy patterns 29A and 29B may be removed after the generation of the drawing data 64A to 64C and may be left to remain when there is no influence thereof on the on-wafer pattern.

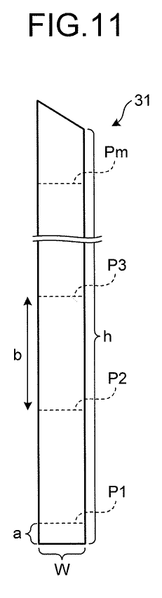

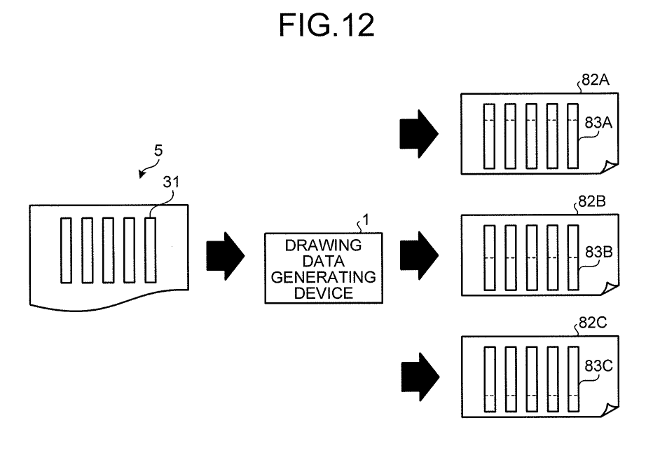

Next, a process of setting a plurality of separation positions for one piece of drawing data will be described. FIG. 11 is a diagram that illustrates the process of setting a plurality of separation positions for the pattern data. Here, a case will be described in which the size of the line end setting pattern in the longitudinal direction is pattern length h, and the length of a side out of sides of a drawing shot in the same direction as the direction of the pattern length h is size b.

The line end setting unit 14 sets a pattern satisfying a division condition as a line end setting pattern. For example, the division condition is for a pattern satisfying that the pattern length h of the line end setting pattern is a predetermined value or more, and the size (pattern width W) in the direction of a short side is a predetermined value or less. The line end setting unit 14, for example, sets a pattern having a pattern length h that is the size b of one side of a drawing shot or more and a pattern width W that is 1/10 of the size b of one side of the drawing shot or less as a line end setting pattern. When the line end setting unit 14 sets line ends at a plurality of positions for the line end setting pattern, the division area setting unit 15 performs the process of setting separation positions for each line end that has been set.

The division area setting unit 15, for example, sets the position of the line end as a separation position of the first drawing shot. The line end, for example, is set to a position that is separated from one end portion of the pattern data 31 by distance a in the longitudinal direction, and a separation position P1 of the first drawing shot is set at this position.

In addition, the division area setting unit 15 sets a position that is separated from the separation position P1 of the first drawing shot by the size b of one side of the drawing shot in the longitudinal direction of the pattern data 31 as a separation position P2 of a second drawing shot.

Similarly, the division area setting unit 15 sets a position that is separated from the separation position P2 by b in the longitudinal direction of the pattern data 31 as a separation position P3 of a third drawing shot. Subsequently, similarly, for the pattern data 31, fourth and fifth separation positions (not illustrated in the figure) and an m-th (here, m is a natural number) separation position Pm are sequentially set. Then, when a remaining pattern length of the pattern data 31 for which a separation position has not been set is a predetermined value or less, the division area setting unit 15 ends the process of setting separation positions. In other words, when a remaining division pattern length is a predetermined value or less, the division area setting unit 15 does not perform final division. Here, the predetermined value is a value within an allowed range in which a drawing shot can be expanded for the size b of one side of the drawing shot. From this, a process of dividing a fine graphic is avoided. In addition, the pattern data 31, as illustrated in FIG. 11, may be generated such that the end portion is in the inclination direction with respect to the longitudinal direction.

In the line end set at a position separated from one end portion in the longitudinal direction of the pattern data 31 by distance a, a plurality of types of distances a are set. For example, in a case where N types of distances a are set for the size b of one side of a drawing shot, the division area setting unit 15 sets N types of distances a by performing shifting by a distance acquired by equally dividing the size b by N.

For example, in a case where the length of one side of a drawing shot is 0.5 μm, and four types of distance a are set as the line end, the division area setting unit 15 sets four types of a=0 μm, a=1.25 μm, a=2.5 μm, and a=3.75 μm as the line end. Then, for each one of the four types of line ends, separation positions of the pattern data 31 are set. As a result, four types of drawing data acquired by shifting the division positions are generated.

In addition, the distance a is not limited to being set by performing shifting by each distance acquired by equally dividing the size b by N, and any distance may be set. For example, N types of random values within the size b are set, and the set random values may be set as the distances a. In such a case, when the length of one side of a drawing shot is 0.5 μm, N types of values less than 0.5 μm are set as the distances a.

FIG. 12 is a diagram that illustrates drawing data generated based on pattern data. As illustrated in the figure, the drawing data generating device 1 generates a plurality of types of drawing area data (drawing area data 82A to 82C) for the multiple exposure setting area 5 including a plurality of pieces of pattern data 31. The drawing area data 82A is generated using drawing data 83A separated at the first separation position, and the drawing area data 82B is generated by using drawing data 83B separated at the second separation position. In addition, the drawing area data 82C is generated by using drawing data 83C separated at the third separation position. In this way, the drawing data generating device 1 sets various separation positions at the pattern data 31, thereby generating a plurality of types of drawing area data.

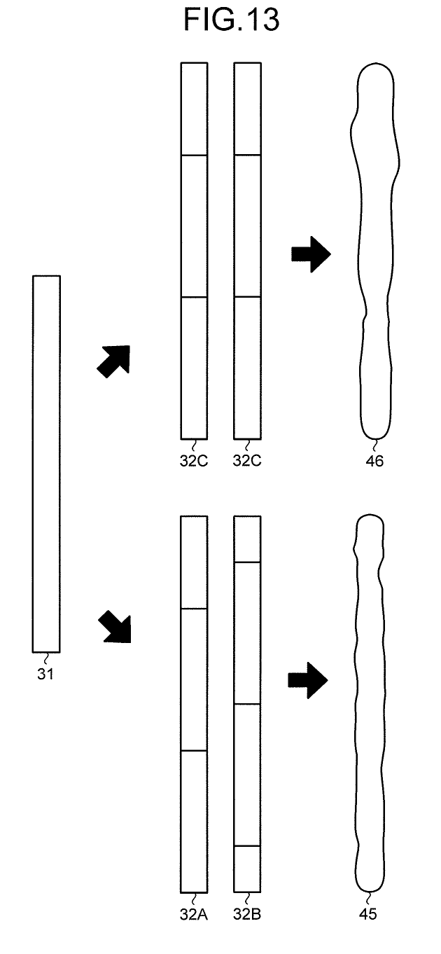

FIG. 13 is a diagram that illustrates the shape of a drawing pattern formed on a substrate by using a plurality of types of drawing data. For example, in a case where one type of drawing data 32C is generated for the pattern data 31, and multiple exposures are performed using the one type of drawing data 32C for the substrate, thickening or thinning of an on-substrate pattern 46 may easily occur near the separation position of the drawing data 32C. The reason for this is that a joint portion of drawing shots overlaps each other at the same position, and thus, a variation in the size at the joint portion of drawing shots remains to be highlighted even after the multiple exposures.

On the other hand, as in this embodiment, in a case where a plurality of types (here, two types) of drawing data 32A and 32B are generated for the pattern data 31, and multiple exposures are performed using the drawing data 32A and 32B for the substrate, it is possible to form an on-substrate pattern 45 having a stable size also near the separation position of the drawing data 32A and 32B. The reason for this is that multiple exposures are performed using a plurality of types of drawing data, and thus, joint portions deviate for each exposure of the multiple exposures. Accordingly, compared to a case where there is no deviation in joint portions of drawing shots, a variation in the size of the on-substrate pattern decreases. In other words, by shifting the connection positions of drawing shots, a variation in the size at the connection positions of drawing shots decreases.

After the drawing data is generated using the pattern data 31, an on-substrate pattern is formed on the substrate by using the drawing data. For example, in a case where the substrate is a template, a template pattern corresponding to the drawing data is drawn on the template. From this, a template having a pattern corresponding to the drawing data is produced.

When an on-substrate pattern is drawn on a substrate such as a template, the substrate is coated with a resist. Then, by performing EB drawing of a pattern corresponding to the drawing data from the upper side of the resist, a pattern corresponding to the drawing data is formed on the substrate.

Thereafter, a semiconductor device (semiconductor integrated circuit) is manufactured by using the produced template. More specifically, after a processing film is formed on a wafer, the processing film is coated with a resist. Then, an imprinting device performs an imprinting process using the template for the wafer coated with the resist. From this, a resist pattern is formed on the wafer.

On the other hand, in a case where the substrate is a photomask (mask blanks), a mask pattern corresponding to drawing data is drawn on the photomask. From this, the photomask corresponding to the drawing data is produced. In this case, a semiconductor device is also produced by using the produced photomask. More specifically, an exposure device performs an exposure process using the photomask for the wafer coated with the resist. Thereafter, by developing the wafer, a resist pattern is formed on the wafer.

After the resist pattern is formed on the wafer, a lower layer side (processing film) of the wafer is etched using the resist pattern as a mask. From this, an on-wafer pattern corresponding to the resist pattern is formed on the wafer. In addition, in a case where the substrate is a wafer, an on-wafer pattern corresponding to the drawing data is directly drawn on the wafer.

When a semiconductor device is manufactured, the generation of the pattern data 31, the generation of a plurality of types of drawing data, the formation of a drawing pattern on the substrate through multiple exposures, a lithography process for the wafer using the substrate, the etching process of the processing film, which have been described above, and the like are repeated for each layer.

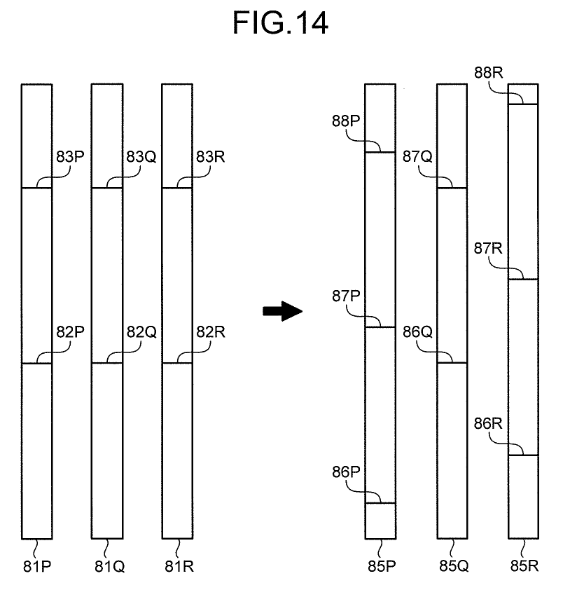

In addition, the setting of separation positions is not limited to a case in which separation positions located at the same position for each pattern within each pattern group are set, and separation positions that are different for each pattern may be set. FIG. 14 is a diagram that illustrates drawing data in a case where separation positions that are different for each pattern are set.

The drawing data 81P, 81Q, and 81R are drawing data in a case where the same separation positions are set for each pattern within the pattern group, and the drawing data 85P, 85Q, and 85R are drawing data in a case where separation positions that are different for each pattern are set.

When the separation positions are set for a pattern group configured by patterns having the same shape, each pattern is separated at the same separation position. In other words, a separation position 82P of the drawing data 81P, a separation position 82Q of the drawing data 81Q, and a separation position 82R of the drawing data 81R are set to the same position within the pattern. Similarly, a separation position 83P of the drawing data 81P, a separation position 83Q of the drawing data 81Q, and a separation position 83R of the drawing data 81R are set to the same position within the pattern.

When separation positions different for each pattern are set, a separation position 86P of the drawing data 85P, a separation position 86Q of the drawing data 85Q, and a separation position 86R of the drawing data 85R are set to different positions within the pattern. Similarly, a separation position 87P of the drawing data 85P, a separation position 87Q of the drawing data 85Q, and a separation position 87R of the drawing data 85R are set to different positions within the pattern. In addition, a separation position 88P of the drawing data 85P and a separation position 88R of the drawing data 85R are set to different positions within the pattern. When separation positions different for each pattern are set, as above, joint portions of drawing shots for adjacent patterns are not adjacent to each other. Since there is a discrepancy between joint portions of drawing shots of patterns adjacent to each other, it is possible to prevent the formation of a short circuit (unintended pattern bonding) occurring between adjacent patterns.

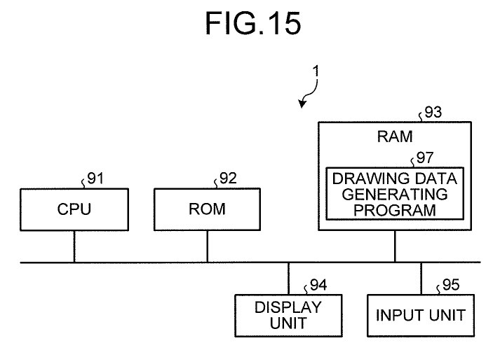

Next, the hardware configuration of the drawing data generating device 1 will be described. FIG. 15 is a diagram that illustrates the hardware configuration of the drawing data generating device. The drawing data generating device 1 includes a central processing unit (CPU) 91, a read only memory (ROM) 92, a random access memory (RAM) 93, a display unit 94, and an input unit 95. In the drawing data generating device 1, the CPU 91, the ROM 92, the RAM 93, the display unit 94, and the input unit 95 are interconnected through a bus line.

The CPU 91 generates drawing data using a drawing data generating program 97 that is a computer program. The drawing data generating program 97 is a computer program product having a computer-readable recording medium including a plurality of instructions, which can be executed by a computer, used for generating drawing data. The drawing data generating program 97 executes generation of drawing data in accordance with the plurality of instructions on a computer.

The display unit 94 is a display device such as a liquid crystal monitor and displays the pattern data 31, a plurality of types of drawing data, the multiple exposure setting area 5, and the like based on an instruction supplied from the CPU 91. The input unit 95 is configured to include a mouse and a keyboard and receives instruction information (a parameter that is necessary for generation of drawing data and the like) that is externally input from a user as an input. The instruction information input to the input unit 95 is transmitted to the CPU 91.

The drawing data generating program 97 is stored in the ROM 92 and is loaded into the RAM 93 through a bus line. FIG. 15 illustrates a state in which a drawing data generating program 97 is loaded into the RAM 93.

The CPU 91 executes the drawing data generating program 97 that has been loaded into the RAM 93. More specifically, in the drawing data generating device 1, the CPU 91 reads the drawing data generating program 97 from the inside of the ROM 92, expands the program into a program storage area arranged inside the RAM 93, and executes various processes in accordance with an instruction input transmitted from the input unit 95 by a user. The CPU 91 temporarily stores various kinds of data generated when the various processes are performed in a data storage area that is formed inside the RAM 93.

The drawing data generating program 97 executed by the drawing data generating device 1 has a modular configuration including a target area extracting unit 13, a line end setting unit 14, and a division area setting unit 15, and these are loaded into a main memory device and are generated on the main memory device.

In this embodiment, although a case has been described in which a plurality of types of drawing data are generated using the pattern data 31, a plurality of types of drawing data may be generated based on one piece of drawing data. In such a case, by shifting the separation position of drawing data that is generated first to various positions, the other new drawing data is generated. In addition, the drawing data that is generated first may be generated using any method.

In addition, in an area other than the multiple exposure setting area, drawing data may be generated by the drawing data generating device 1 or may be generated by another device. In the area other than the multiple exposure setting area, for example, an on-substrate pattern corresponding to the drawing data is drawn on the substrate by one exposure.

According to the embodiment as above, a plurality of types of drawing data having different separation positions of drawing shots are generated, and multiple exposures are performed using the generated plurality of types of drawing data, and accordingly, it is possible to decrease a size variation in the joint portions of drawing shots. Accordingly, an on-substrate pattern having a desired size can be formed.

In addition, since a plurality of types of drawing data are generated for the multiple exposure setting area, it can be avoided that the data amount of data used when the drawing data is generated or a processing time required for generating the drawing data becomes large.

Furthermore, since a plurality of types of line ends are set by performing shifting by each distance acquired by equally dividing the size b of one side of the drawing shot by N, the separation positions of drawing shots can be uniformly arranged on the pattern data 31. Accordingly, the on-substrate data corresponding to the pattern data 31 can be drawn on the substrate in a stable size.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of forming a drawing pattern, the method comprising:
generating drawing data based on pattern data by setting positions of drawing shots for the pattern data of a drawing pattern that is drawn on a substrate;
forming the drawing pattern on the substrate by drawing a drawing pattern corresponding to the drawing data on the substrate;
generating a plurality of types of drawing data based on one type of pattern data by setting the positions of the drawing shots to positions different for each piece of the drawing data when the drawing data is generated; and
performing multiple exposures for the substrate by using the plurality of types of the drawing data when the drawing pattern is formed.

2. The method according to claim 1, wherein the plurality of types of the drawing data are generated by shifting the positions of the drawing shots set for the pattern data for each piece of the drawing data in the pattern data.

3. The method according to claim 2, wherein the plurality of types of the drawing data are generated by shifting the positions of the drawing shots within the pattern data by each value acquired by dividing a size of one side of the drawing shots by a natural number of two or more for each piece of the drawing data.

4. The method according to claim 1, further comprising extracting a multiple exposure setting area for which multiple exposures are performed for the substrate from the pattern data based on a predetermined extraction condition,
wherein, when the drawing data is generated, the plurality of types of the drawing data are generated for the pattern data of the multiple exposure setting area, and
wherein, when the drawing pattern is formed, multiple exposures are performed for the multiple exposure setting area.

5. The method according to claim 1,
wherein a plurality of types of line ends that are reference positions at the time of setting the separation positions of the drawing shots are set in the pattern data, and
wherein the plurality of types of the drawing data are generated by setting the drawing shots for each line end such that the separation positions of the drawing shots coincide with the line ends.

6. The method according to claim 5, wherein a plurality of types of the line ends are set by setting a plurality of types of offset sizes for the original line end and setting positions moved from the original line end by the offset sizes as the line ends that are the reference positions.

7. The method according to claim 5, wherein the plurality of types of the line ends are set by setting microscopic patterns that are not resolved on the substrate as a plurality of types of positions in a longitudinal direction of the pattern data and setting positions of the microscopic patterns as the line ends that are the reference positions.

8. The method according to claim 5, wherein the plurality of types of the line ends are set by setting a plurality of types of expansion/contraction sizes for the original line end and setting positions moved from the original line end by the expansion/contraction sizes as the line ends that are the reference positions.

9. The method according to claim 5, wherein the plurality of types of the line ends are set by setting dummy patterns at positions separated from the original line end by a plurality of types of distances in a longitudinal direction and setting line ends of the dummy patterns as the line ends that are the reference positions.

10. The method according to claim 1, wherein the substrate is a template, and the drawing pattern is a template pattern.

11. The method according to claim 4, wherein the predetermined extraction condition is a condition relating to a pattern length and a pattern width of the pattern data.

12. A method of generating a drawing data, the method comprising:
generating drawing data based on pattern data by setting positions of drawing shots for the pattern data of a drawing pattern that is drawn on a substrate; and
generating a plurality of types of drawing data based on one type of pattern data by setting the positions of the drawing shots to positions different for each piece of the drawing data when the drawing data is generated.

13. The method according to claim 12, wherein the plurality of types of the drawing data are generated by shifting the positions of the drawing shots set for the pattern data for each piece of the drawing data in the pattern data.

14. The method according to claim 13, wherein the plurality of types of the drawing data are generated by shifting the positions of the drawing shots within the pattern data by each value acquired by dividing a size of one side of the drawing shots by a natural number of two or more for each piece of the drawing data.

15. The method according to claim 12, further comprising extracting a multiple exposure setting area for which multiple exposures are performed for the substrate from the pattern data based on a predetermined extraction condition,
wherein, when the drawing data is generated, the plurality of types of the drawing data are generated for the pattern data of the multiple exposure setting area, and
wherein, when the drawing pattern is formed, multiple exposures are performed for the multiple exposure setting area.

16. The method according to claim 12,
wherein a plurality of types of line ends that are reference positions at the time of setting the separation positions of the drawing shots are set in the pattern data, and
wherein the plurality of types of the drawing data are generated by setting the drawing shots for each line end such that the separation positions of the drawing shots coincide with the line ends.

17. The method according to claim 16, wherein a plurality of types of the line ends are set by setting a plurality of types of offset sizes for the original line end and setting positions moved from the original line end by the offset sizes as the line ends that are the reference positions.

18. The method according to claim 16, wherein the plurality of types of the line ends are set by setting microscopic patterns that are not resolved on the substrate as a plurality of types of positions in a longitudinal direction of the pattern data and setting positions of the microscopic patterns as the line ends that are the reference positions.

19. A drawing data generating device comprising:
an input unit that receives pattern data of a drawing pattern that is drawn on a substrate as an input; and
a drawing shot setting unit that generates drawing data based on the pattern data by setting positions of drawing shots for the pattern data,
wherein the drawing shot setting unit generates a plurality of types of drawing data based on one type of pattern data by setting the positions of the drawing shots to positions different for each piece of the drawing data when the drawing data is generated.

20. The drawing data generating device according to claim 19, further comprising:
an extraction unit that extracts a multiple exposure setting area for which multiple exposures are performed for the substrate from the pattern data based on a predetermined extraction condition,
wherein the drawing shot setting unit, when the drawing data is generated, generates the plurality of types of the drawing data for the pattern data of the multiple exposure setting area.
